(19) United States
(12) Patent Application Publication
(10) Pub. No.: US 2007/0117959 A1
(43) Pub. Date: May 24, 2007

(54) Novel polyesters

(75) Inventors: Venkatram P Shastri, Nashville, TN (US); Xiao-Jun Xu, Philadelphia, PA (US)

Correspondence Address: RATNERPRESTIA, P O BOX 980, VALLEY FORGE, PA, 19482-0980, US

(73) Assignee: The Children's Hospital of Philadelphia, Philadelphia, PA (US)

(21) Appl. No.: 10/583,016

(22) PCT Filed: Dec. 15, 2004
(86) PCT No.: PCT/US04/41942

§ 371 Date: Jun. 15, 2006

Related U.S. Application Data
(60) Provisional application No. 60/529,716, filed on Dec. 15, 2003.

(51) Int. Cl. C08G 63/08

(52) U.S. Cl. 528/272; 528/354

(57) ABSTRACT

A polyester including a macromeric unit, wherein the macromeric unit has (a) at least two lactone derived units, (b) an initiating core, and (c) a coupling unit, wherein the initiating core is linking the at least two lactone derived units to form a macromerdiol and wherein the coupling unit and the initiating core have a carbon chain of a length sufficient to alter hydrophobicity of the polyester, and thereby enable the polyester to degrade according to a surface erosion mechanism. The polyesters of the present invention are suitable for a wide range of biomedical applications including drug delivery, imaging, scaffolding for tissue engineering, coating of various surfaces such as for example implantable devices as well as colloids and microparticles. FIG. 1 is a reaction scheme depicting the preparation of polyesters of the invention.

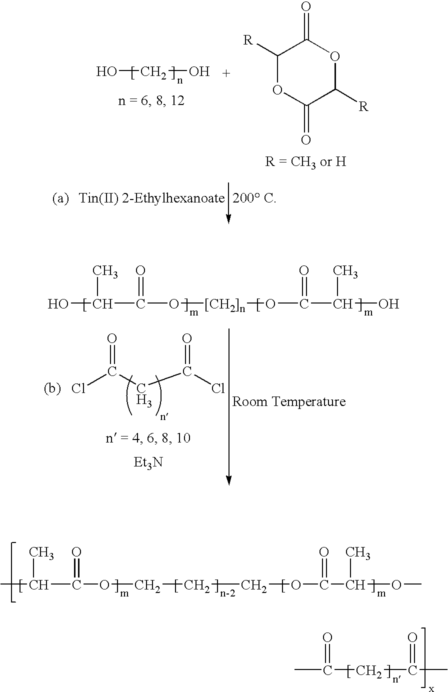

### CROSS-REFERENCE TO RELATED APPLICATIONS

This application claims the benefit of provisional Application No. 60//529,716 filed on Dec. 15, 2003, which is incorporated herein in its entirety.

### STATEMENT REGARDING FEDERALLY SPONSORED RESEARCH OR DEVELOPMENT

This research was supported in part by U.S. Government funds (National Institute of Health Grant No. R24-AI47739-03), and the U.S. Government may therefore have certain rights in the invention.

### BACKGROUND OF THE INVENTION

1. Field of Invention

This invention relates to biodegradable polymers, and more particularly to polymers capable of degrading by a surface erosion mechanism.

2. Description of Related Art

Biodegradable polymers have been extensively used in various biomedical applications ranging from controlled drug delivery, imaging, and tissue engineering (Langer, R. Nature 1998, 392, 5-10; Langer, R.; Vacanti, J. P. Science 1993, 260, 920-926).

Among the biodegradable polymers, poly(alpha-hydroxy acids) (PHAs) including poly(lactic acid) (PLA), poly(glycolic acid) (PGA), and poly(lactide-co-glycolide) (PLGA) are most often used due to their superior biocompatibility and long clinical history.

Polymers' degradation mechanism is an important factor in selection of polymers for biomedical applications. Most biodegradable polymers undergo degradation through the bulk erosion mechanism. Bulk erosion results in the formation of bulk porosity, which translates into non-linearity in degradation and drug release. Other consequences of bulk erosion are unpredictable changes and loss in mechanical properties. These factors can severely impact performance of implants in load bearing settings. Exceptions to this generality are poly(ortho-esters) (POEs) and poly(anhydrides) (PAs), which undergo degradation through the surface erosion mechanism (see Heller, J. In Handbook of Biodegradable Polymers; Domb, A. J.; Kost, J.; Wiseman, D. M., Eds.; Harwood Academic Publishers: Amsterdam, 1997; pp 99-118 and Domb, A. J.; Elmalak, O.; Shastri, V. R.; et al.). Advantages of surface erosion include linear drug release kinetics and gradual changes in mechanical properties. In spite of these potential benefits, both POE and PA have limited applications in drug delivery and tissue engineering due to the poor tunability of the polymer backbone and, additionally, in the case of PAs, due to the reactivity of the anhydride backbone.

In the past three decades, biodegradable synthetic polymers have been used in fracture fixation devices. Currently, several polymers are being evaluated for fracture fixation including poly(alpha-hydroxy acids) (PLA, PGA), poly(p-dioxanone), and poly(iminocarbonates). While these polymers appear promising and some have even found clinical applications, their use has been severely limited by performance issues. Several studies illustrate factors hampering the biocompatibility and performance of polymeric materials such as PGA and PLGA in fracture fixation devices. For example, local accumulation of degradation products can lead to a chronic inflammatory response (see Anderson, Inflammatory response to implant, Trans. Am. Soc. Intern. Organs, 34:101-107 (1998)). Non-specific degradation of implants and rapid degradation of implant material at latter stages can result in a premature mechanical failure of the implant and an acute inflammatory response (see Bostman, Absorbable polyglycolide pins in internal fixation of fractures in children, J. Pediatrics Orthopedics, 13:242-245 (1993) and Weiler, Biodegradable implants in sports medicine: The biological base, J. Arthrosc. Rel. Surg., 16:305-321 (2000)). These consequences are thought to affect new bone formation around the implant (see Bergsman, Late degradation tissue response to poly(L-lactide) bone plates and screws, Biomaterials, 16:25-31 (1995)).

While poly (alpha-hydroxy acids) and other polyesters appear promising, they do not possess all the desired characteristics for drug delivery systems and implants.

Therefore, there is a need for biodegradable polymers that can be used for biomedical applications and have improved material characteristics such as good tensile and compressive modulus even at extended mass loss, minimal changes in acidity of the local environment, erosion rates that are similar to bony tissue in-growth, and osteo-conductive ability.

All references cited herein are incorporated herein by reference in their entireties.

### BRIEF SUMMARY OF THE INVENTION

Accordingly, the invention provides a polyester comprising a macromeric unit, wherein the macromeric unit comprises (a) at least two lactone derived units, (b) an initiating core, and (c) a coupling unit. In certain embodiments, the initiating core is linking at least two lactone derived units to form a macromerdiol. In certain embodiments, the coupling unit is linking a plurality of macromerdiols. In certain embodiments, the coupling unit and the initiating core have a carbon chain of a length sufficient to alter hydrophobicity of the polyester and thereby enable the polyester to degrade according to a surface erosion mechanism.

In certain embodiments, the polyester has the following structural formula:
[-[A]ₘ-[B]-[A]ₘ-[D]-]ₓ
wherein A is a lactone derived unit, B is the initiating core, D is the coupling unit, m is a number of repeats from about 4 to about 60, and x is a number of macromeric units from 1 to about 100. In certain embodiments, m is 10 to 40.

In certain embodiments, A is represented by at least one of the formulas:
—[—(R₂)—C(═O)—O—]— and —[—O—C(═O)—(R₂)—]—
wherein R₂ is at least one of C₁-C₈ alkyl and a substituted C₁-C₈ alkyl having at least one carbon substituted with an aromatic group and/or a heteroatom.

In certain embodiments, B is represented by the formula:
—[R₁]—
wherein R₁ is a member selected from the group consisting of a C₂-C₁₄ linear alkyl, a substituted C₂-C₁₄ alkyl having at least one substituent group, a C₂-C₁₄ heteroalkyl, a C₂-C₁₄ branched alkyl, an alkyl having at least one unsaturated bond, and a polymer.

In certain embodiments, R₁ is a member selected from the group consisting of C₆, C₈, C₁₀ and C₁₂ alkyls, a poly(ether), poly(ethylenglycol), poly(amine), poly(propyleneoxide), block ABA copolymers of poly(oxyethylene) and poly(oxypropylene).

In certain embodiments, C is represented by the formula:
[—C(═O)—(R₃)—C(═O)—]

wherein R₃ is a C₄-C₁₀ aliphatic or aromatic group. In certain embodiments, R₃ is a member selected from the group consisting of C₄, C₆, C₈, and C₁₀ alkyls.

Further provided is a polyester comprising a macromeric unit, wherein the macromeric unit comprises (a) at least two lactone derived units, (b) an initiating core, wherein the diol derived unit is linking at least two lactone derived units to form a macromerdiol; and (c) a coupling unit, wherein the coupling unit is linking a plurality of macromerdiols and wherein the coupling unit and the diol derived unit have a carbon chain of a length sufficient to alter hydrophobicity of the polyester, and thereby enable the polyester to degrade according to a surface erosion mechanism.

Also provided is a process of making the polyester of the invention, the process comprising providing a lactone, providing a diol, providing a coupling agent, reacting the lactone with the diol in a presence of a catalyst to form a macromerdiol, and reacting the macromerdiol with the coupling agent to form the polyester.

In certain embodiments, the catalyst is a member selected from the group consisting of tin(II)-2-ethylhexanoate, aluminum isopropoxide, salts and oxides of yttrium and lanthanide.

In certain embodiments, the lactone is a member selected from the group consisting of lactones of alpha-hydroxy acids, lactones of beta-hydroxy acids, lactones of omega-hydroxy acids, lactones of gamma-hydroxy acids, lactones of delta-hydroxy acids, lactones of epsilon-hydroxy acids, p-dioxanone, cyclic carbonates, optical isomers thereof, substituents and mixtures thereof.

In certain embodiments, the lactone is lactide, ε-caprolactone, propiolactone, butyrolactone, valerolactone, p-dioxanone, depsipeptide or a mixture thereof.

In certain embodiments, the diol has the following structural formula:
HO—(R₁)—OH
wherein R₁ is a member selected from the group consisting of a C₂-C₁₄ linear alkyl, a substituted C₂-C₁₄ alkyl having at least one substituent group, a C₂-C₁₄ heteroalkyl, a C₂-C₁₄ branched alkyl, an alkyl having at least one unsaturated bond, and a polymer.

In certain embodiments, the coupling agent is an acyl halide.

In certain embodiments, the coupling agent is a diacyl chloride derived from adipic acid, suberoic acid, sebacic acid, or dodecanoic acid.

Further provided is a device manufactured from the polyester of the invention. In certain embodiments, at least a part of the device is adapted to be implanted in a body. In certain embodiments, at least a part of the device is adapted to deliver a bioagent.

In certain embodiments of the composition, the bioagent is an antibody, a viral vector, a growth factor, a bioactive polypeptide, a polynucleotide coding for the bioactive polypeptide, a cell regulatory small molecule, a peptide, a protein, an oligonucleotide, a gene therapy agent, a gene transfection vector, a receptor, a cell, a drug, a drug delivering agent, nitric oxide, an antimicrobial agent, an antibiotic, an antimitotic, an antisecretory agent, an anti-cancer chemotherapeutic agent, steroidal and non-steroidal anti-inflammatories, a hormone, an extracellular matrix, a free radical scavenger, an iron chelator, an antioxidant, an imaging agent, or a radiotherapeutic agent.

### BRIEF DESCRIPTION OF SEVERAL VIEWS OF THE DRAWINGS

The invention will be described in conjunction with the following drawings in which like reference numerals designate like elements and wherein:

FIG. 1 is a reaction scheme depicting the preparation of polyesters of the invention, demonstrating (a) a reaction between a diol and a poly(hydroxy acid) (PHA)-derived lactone in the presence of a catalyst to form a mactomerdiol (MD) and (b) a reaction between the MD formed in the previous reaction and a coupling agent, an acyl halide, to form the polyester of the invention.

FIG. 2 is a bar graph showing the effect of PLA/PLGA chain length and an initiator's core length on melting temperature (T_{g}) of MDs, wherein the initiator is 1,6-hexanediol (H), 1,8-octanediol (O), and 1,12-dodecanediol (D).

FIGS. 3A-3C are graphs demonstrating chemical characteristics of macromerdiol H20L, wherein FIG. 3A is the FTIR spectrum, FIG. 3B is the ¹H-NMR spectrum, and FIG. 3C is the ¹H-13C correlated (HSQC) spectrum.

FIG. 4A is the FTIR spectrum, and FIG. 4B is the ¹H-NMR spectrum of polyester H20LC6.

FIG. 5 shows degradation profiles of polyesters of the invention (H20LC6, H40LC10, and 40LC10) as compared to profiles of PLA and P(dl)LGA (RG 503) at pH 10.

FIG. 6A-6C are graphs demonstrating chemical characteristics of macromerdiol diol D40L, wherein FIG. 6A is the FTIR spectrum, FIG. 6B is the ¹HNMR spectrum, and FIG. 6C is the ¹H—¹³C correlated (HSQC) spectrum.

FIG. 7 shows typical DSC curves of the macromer diol D40L and polyester D40LC10.

FIGS. 8A-8C are graphs demonstrating chemical characteristics of polyester D40LC10, wherein FIG. 8A is the FTIR spectrum, FIG. 8B is the ¹HNMR spectrum, and FIG. 8C is the ¹H—¹³C correlated (HSQC) spectrum of the polyester.

FIGS. 9A-9C are bar graphs showing the molecular weight polydispersity index (PDI) as a function of a type of the diacid dichloride (1: adipoyl chloride, 2: suberoyl chloride, 3: sebacoyl chloride, and 4: dodecanedioyl dichloride) and PLA/PLGA chain length for polyesters of the invention with the 1,6-hexanediol core (FIG. 9A), the 1,8-octanediol core (FIG. 9B), and the 1,12-dodecanediol core (FIG. 9C).

FIGS. 10A-10C are bar graphs showing the glass transition temperature (T_{g}) as a function of a type of the diacid dichloride (1: adipoyl chloride, 2: suberoyl chloride, 3: sebacoyl chloride, and 4: dodecanedioyl dichloride) and PLA/PLGA chain length for polyesters of the invention with the 1,6-hexanediol core (FIG. 10A), the 1,8-octanediol core (FIG. 10B), or (c) the 1,12-dodecanediol core (FIG. 10C).

### DETAILED DESCRIPTION OF THE INVENTION

The polyester of the invention includes a macromeric unit, wherein the macromeric unit has (a) at least two lactone derived units, (b) an initiating core, and (c) a coupling unit, wherein the initiating core is linking at least two lactone derived units to form a macromerdiol, and wherein the polyester is capable of degrading according to the surface erosion mechanism.

The polyesters of the invention possess surface eroding characteristics being imparted by selecting the length and structure of the initiating core and the coupling unit.

The polyesters of the present invention are suitable for a wide range of biomedical applications including drug delivery, imaging, scaffolding for tissue engineering, coating of various surfaces such as, for example, implantable devices, and manufacturing of implantable devices, colloids and microparticles.

The primary driving force for the bulk erosion degradation mechanism in polymers such as poly(hydroxy acids) (PHAs) is the relative hydrophilicity of the polymer backbone. This allows for the penetration of the aqueous front beyond the surface of the polymer solid and into the bulk. Once degradation sets in, the accumulation of water-soluble degradation products within the polymer causes an osmotic in-flow of water that further accelerates the degradation process. Therefore, in order to modify and modulate the degradation process, the response of the polymer at the water uptake phase must be influenced such that the progression of bulk erosion favoring events is arrested.

Inventors discovered that surface-eroding characteristics could be imparted to polymers such as PHAs, which ordinary degrade by the bulk erosion mechanism, by introducing moieties possessing long alkyl chains along the polymer chain. Furthermore, by using these moieties to separate amorphous/semi-crystalline regions, the hydrophobicity (lipophilicity) of the polymer system can be modulated without significant changes to its crystallinity. The increase in lipophilicity would in turn diminish the water uptake and confer surface-eroding characteristics to the resulting polymer.

Without wishing to be bound by a particular theory, the inventors believe that the present invention reduces or overcomes the above discussed deficiencies in polyesters by modifying the response to these polymers at the water uptake phase. Synthesizing the polymers from at least one type of monomers possessing an alkyl chain backbone is believed to improve the hydrophobicity of the polymer system without detrimentally affecting its crystallinity. It is believed that this increased hydrophobicity in turn diminishes water uptake and confers surface eroding characteristics to the polymer. Characteristics associated with the surface erosion mechanism include lower concentrations of degradation products around the implant and minimal changes in local pH.

Polymers possessing surface erosion characteristics are desirable because they can be used, for example, in drug delivery systems such as sustained release formulations of bioactive agents or in promoting bone growth around an implant.

Polymer Design and Synthesis

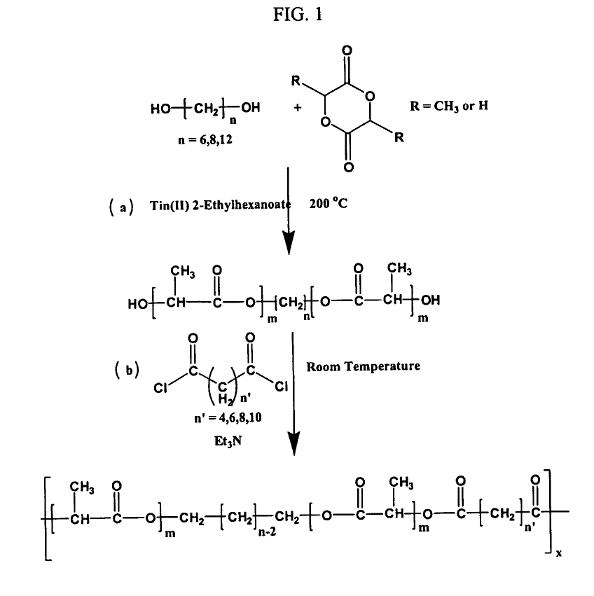

Synthesis of a polyester of the present invention is carried out in two basic steps as show in FIG. 1. First step involves a reaction between a lactone and a diol in a presence of a catalyst to produce macromerdiols (MDs). In this step, one type of lactones or a mixture of several kinds can be used. Second step involves reacting MDs with a coupling agent to produce the polyester of the invention, wherein MDs are coupled together preferably as block polymers. In certain embodiments, the lactone and the diol are provided at a molar ratio of about 5 to about 60. In certain embodiments, the macrodiol and the coupling agent are provided at a molar ratio of about 1 to about 20.

Non-limiting examples of polyesters of the invention are polyesters derived from PHAs. Tables 2-4 represent polyesters of the invention derived from L-lactide and L-lactide/glycolide that exhibit surface-erosion-like behavior. In the first step, various MDs possessing varying degrees of hydrophilic-lipophilic balance (HLB) were synthesized by initiating polymerization of L-lactide or a mixture of L-lactide and glycolide (3/1 molar ratio) to make polymers of various lengths using alkanediols of increasing C-chain lengths (as shown in Table 1).

The use of alkanediol initiators results in the formation of symmetrical MDs having alkane initiating cores and terminal hydroxyl groups. The degree of polymerization (DP) of resulting polyesters depends on the molar ratio of the lactide/glycolide unit to alkanediol.

In the second step, the MDs were coupled to each other using a coupling agent, for example, hydrophobic biocompatible acid halides of various C-chain lengths to further enhance hydrophobicity of the desired polyesters.

It is significant that polyesters of the invention are biocompatible as they are built from biocompatible moieties.

Lactone

A lactone used in the invention is a cyclic ester, which comprises at least one carboxy group and at least one oxy group. Non-limiting examples of lactones which can yield polyesters of the invention include lactones of alpha-hydroxy acids such as lactide and glycolide, lactones of beta-hydroxy acids such as propiolactone, lactones of gamma-hydroxy acids such as butyurolactone, lactones of delta-hydroxy acids such as valerolactone, lactones of epsilon-hydroxy acids such as ε-caprolactone, p-dioxanone, cyclic carbonates, optical isomers thereof (e.g., L-, DL-forms), substituents and mixtures thereof. The lactones used in the invention are capable of polymerizing respectively into, for example, poly(hydroxy acids) such as poly(lactic acid) (PLA), poly(glycolic acid) (PGA), poly(caprolactone)(PCL), poly(lactide co-glycolide) (PLG), poly(gamma-hydroxy butyric acid) (pGHB) and poly(dioxanone). Also, lactones useful in the invention include lactone-lactams (cyclic amides) of alpha hydroxy acids and amino acids 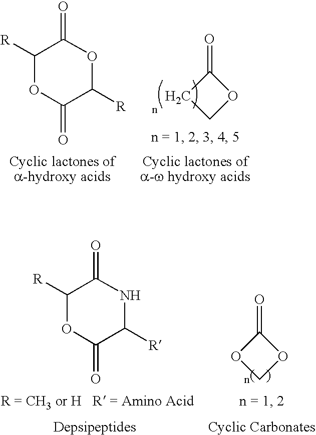
such as, for example, depsipeptides.

The lactones used in the invention can be illustrated by the following structures:

In a preferred embodiment, the lactone is a lactide. The reaction of the lactide with a diol is illustrated by FIG. 1.

During the reaction with diol, the lactone's ring opens to produce at least one lactone derived unit A for subsequent polymerization into a macromerdiol (MD), wherein the lactone derived unit A has the following formula:
—[—(R₂)—C(═O)—O—]— or —[—O—C(═O)—(R₂)—]— (A)

The lactone derived unit A is a monomeric repeating unit and can be repeated in MD more than twice. In certain embodiments of the invention, the number of repetitions m=5 to 60 and in other embodiments m=10 to 40.

R₂ includes a C₁-C₈ alkyl, wherein one or more carbons can be substituted with an aromatic group and/or a heteroatom such as, for example, N.

Diol

A diol used in the invention has the following structural formula:
HO—(R₁)—OH
wherein R₁ is a C₂-C₁₄ alkyl, including a linear alkyl, an alkyl having various substituent groups such as aromatic groups and halogen groups, an alkyl having heterogroups such as O, N, and S along the backbone, a branched alkyl, an alkyl having at least one unsaturated bond, and a polymer. Non-limiting examples of aromatic alkyls include phenyl and dimethylphenyl. Preferred R₁ includes C₆, C₈, C₁₀ and C₁₂ alkyls, a polyether, poly(ethylenglycol) (PEG), poly(amine), poly(propyleneoxide), block ABA copolymers of poly(oxyethylene) (POE) and poly(oxypropylene) (POP, Pluronics).

During the reaction with a lactone to produce MDs, the diol forms an initiating core B having the following structural formula:
—[R₁]— (B)
Marcomerdiols (MDs)

Marcomerdiols (MDs) are formed by the reaction of a lactone and a diol and have the following structural formula:
HO—[—(R₂)—C(═O)—O—]ₘ—[R₁]—[—O—C(═O)—(R₂)—]ₘ—OH
wherein m is a number of repeats from about 4 to about 60; in certain embodiments m=10 to 40.
Coupling Agent

Coupling agents are used in condensation polymerization reaction to link MDs to yield polyesters of the invention. Non-limiting examples of such coupling agents are hydrophobic acyl halides, preferably diacid dichlorides.

Coupling agents have the following structural formula:
X—C(═O)—(R₃)—C(═O)—X
where R₃ is a C₄-C₁₀ aliphatic or aromatic group, preferably R₃ is C₄, C₆, C₈, or C₁₀, X is a halide, preferably Cl. In certain embodiments, diacyls are derived from adipic acid (C₆), suberoic acid (C₈), sebacic acid (C₁₀), and dodecanoic acid (C₁₂).

The carbon chain length in acyl halides is one of the parameters that can be used to influence the hydrophobicity and degradation behavior of the polymer by altering the chain length until the desired effect of surface erosion characteristic in the polymer is reached.

During the reaction with MDs, the coupling agent forms a coupling unit D having the following formula:
[—C(═O)—(R₃)—C(═O)—] (D)
Polyesters of the Present Invention

Polyesters of the present invention have the following structural formula:
[-[A]ₘ-[B]-[A]ₘ-[D]-]ₓ
where m is a number of repeats from about 4 to about 60, and x is a number of macromeric units from about 1 to about 100. The term “marcomeric unit” as used in this disclosure means a repeating unit formed from a combination of repeating lactone derived units (homo and hetero monomers), an initiating core, and a coupling unit.

In certain embodiments, lactone derived units constitute about 10% to about 99% of the polyester. In other embodiments, lactone derived units constitute 50% to 99% of the polyester.

In certain embodiments, the lactone derived unit has a number average molecular weight of about 50 to about 12,000. In certain embodiments, the number average molecular weight is 50 to 6,000 or 50 to 2,000. In certain embodiments, the polyester has a molecular weight from about 20 KDa to about 120 KDa.

Biomedical Applications

The polyesters of the present invention can be used in a wide range of biomedical applications including drug delivery, imaging, scaffolding for tissue engineering, coating of various surfaces such as, for example, implantable devices, manufacturing of implantable devices, colloids and microparticles (e.g., sized from about 10 nm to about 100 microns). For example, the polyester invention can be used in a vascular graft or orthopedic implant device such as a staple, a pin, a suture, a rod, a ligating clip, a vascular graft or a mesh. The polyesters of the present invention can be used in, for example, bowel anastomosis, anastomosis of the ureter, sutureless anastomosis and nerve growth conduits. Additionally, it can be employed in fraction fixation devices such as, for example, a plate or screw. The polyesters of the present invention can also be used for bone augmentation to heal defects in bone caused by trauma or tumor removal. The polyesters of the present invention can also be used instead of a bone graft, thereby eliminating the need for extracting bone from another site of the patient. Another area of use for polyesters of the present invention is ligament reconstruction.

The orthopedic biomedical applications for the present invention can vary in hardness requirements. As the length of an alkyl chain of one of the starting monomers is lengthened, the polyester of the present invention becomes softer; hence, one can tailor the chain length and resulting softness of the polyester product. The total chain length of a diol, a repeating unit and a diacyl can also be tailored in accordance with desired applications.

While the polyesters of the present invention can be used for manufacturing of e.g., biodegradable orthopedic or cardiovascular implants, they can also be used as drug delivery vehicles by incorporating various bioactive agents into the polyesters of the devices, wherein the release of the bioactive agents will be controlled by the surface erosion mechanism. The polyesters of the present invention also can be used for drug delivery of a pharmaceutically active agent.

One example of using polyesters of the invention in drug delivery systems includes fabrication of reservoir caps in microchip delivery devices (see Grayson, A. C. R.; Choi, I. S.; Tyler, B. M.; Wang, P. P.; Brem, H.; Cima, M. J.; Langer, R. Nature Materials 2003, 2, 767-772).

Incorporation of bioactive agents into the polyesters of the invention can be performed by methods known in the art, wherein bioactive agents may be bound to the polyesters by covalent bonding or physically trapped within the polyester's structure. Covalent bonding can be achieved by various methods known in the art including chemical modification, photo-chemical activation, etc.

For example, it would be useful to include an antibiotic in an implant. Also, the rate of bone healing and growth could be accelerated by incorporating appropriate substances such as hydroxyapatite, tricalcium phosphate, and beta-glycerol, growth factors, or enzymes into the polyester employed for a bone implant.

Non-limiting examples of polyesters of the invention in combination with bioactive agents include a wafer for oral administration or implant, a microsphere, microcapsule, or colloidal composition, wherein the bioactive agent is covalently or non-covalently associated with the polyester or entrapped in the polyester. Association of bioactive agents with polyester of the invention can be performed by methods known in the art as described above.

Bioactive Agent

Non-limiting examples of the bioactive agents include an antibody, a viral vector, a growth factor, a bioactive polypeptide, a polynucleotide coding for the bioactive polypeptide, a cell regulatory small molecule, a peptide, a protein, an oligonucleotide, a gene therapy agent, a gene transfection vector, a receptor, a cell, a drug, a drug delivering agent, nitric oxide, an antimicrobial agent, an antibiotic, an antimitotic, dimethyl sulfoxide, an antisecretory agent, an anti-cancer chemotherapeutic agent, steroidal and non-steroidal anti-inflammatories, a hormone, an extracellular matrix, a free radical scavenger, an iron chelator, an antioxidant, an imaging agent, and a radiotherapeutic agent.

Additionally, the biomaterial can be either component of an affinity-ligand pair. Examples of such affinity ligand pairs include avidin-biotin and IgG-protein A. Furthermore, the biomaterial can be either component of a receptor-ligand pair. One example is transferring and its receptor. Other affinity ligand pairs include powerful hydrogen bonding or ionic bonding entities such as chemical complexes. Examples of the latter include metallo-amine complexes. Other such attractive complexes include nucleic acid base pairs formed by immobilization oligonucleotides of a specific sequence, especially antisense. Nucleic acid decoys or synthetic analogues can also be used as pairing agents to bind a designed gene vector with attractive sites. Furthermore, DNA binding proteins can also be considered as specific affinity agents; these include such entities as histones, transcription factors, and receptors such as the glucocorticoid receptor.

Polymer Chemical and Mechanical Characterization

Various conventional methodologies are available to assess chemical and mechanical characteristics of the polymers of the present invention. Chemical characteristics, for example, can be assessed with ¹H and ¹³ C-NMR, which can be used to ensure purity of building blocks of the polymer and to characterize the final polymer composition with respect to group analysis, degree of polymerization, and monomer incorporation ratio. FTIR can be used to verify monomer and polymer purity and to analyze degradation products. Gel permeation chromatography is useful in determining the number and weight average molecular weight and polydispersity of the polymer against traditional standards such as polystyrene and PMMA.

For the assessment of the mechanical aspects of the polymer, the modulus (ε) of fibers and films can be determined by using ASTM methods with an Instron testing equipment (Instron, Canton, Mass.). Degradation studies can be performed by using extruded or compressed rod and pellet specimens in simulated body fluid at 37° C. under sink conditions, (i.e., adequate solubility in an adequate volume of the dissolution media) to ascertain the mass loss as function of incubation time. Modulus of the degraded specimens can be obtained to ascertain changes in mechanical properties during degradation. The pH of the incubation medium can also be monitored to assess changes in the local acidity of the polymer.

Polymer Biological Characterization

There are various in vitro and in vivo techniques for assessing the biological compatibility of polymers produced in accordance with the present invention. For example, for the in vitro assessment of cytocompatibility, the attachment and proliferation of NIH 3T3 fibroblasts can be used as a model system to measure the biocompatibility of the polymers of the present invention. Cell proliferation can be determined by using an MTT assay.

Osteo-conductivity and compatibility of the polymers of the present invention can also be used in a standard animal model such as a trans-cortical rabbit tibia model. Osteo-conductivity and compatibility are preferably assessed after implantation in an appropriate animal model. The osteo-conductivity of the polymer can be further enhanced with the addition of calcium salts such as hydroxyapatite (Hap), tricalcium phosphate (TCP) and beta-glycerol phosphate into the polymer implant.

After being implanted in an animal model, the remainder of the polymer material can be mechanically removed and further analyzed. Prior to further analysis, the polymer can be treated to remove organic components with an enzyme solution such as trypsin and collagenase Ia, present in a Hank's balanced salt solution. Following the removal of organic components, the polymer can be dried under vacuum. NMR or SEM can then be used to evaluate the chemical characteristics of the removed sample. Samples can also be removed from an animal model at set time intervals, allowing for the measurement of physical changes, such as changes in mass of viscosity.

The invention will be illustrated in more detail with reference to the following Examples, but it should be understood that the present invention is not deemed to be limited thereto.

### EXAMPLES

### Example 1

### Synthesis of Macromerdiols (MDs)

A series of MDs composed of various initiating cores (C₆, C₈, C₁₀, and C₁₂) and L-lactide or L-lactide/glycolide chain length (m=10, 20, 30 and 40) were prepared (Table 1). As an example, the synthesis of MD of 1,6-hexanediol with L-lactide is described below. A 50-mL round-bottomed flask was charged with 0.409 g of 1,6-hexanediol, 10 g of L-lactide (20 mol of L-lactide/mol of diol), 21 mg of Tin(II) 2-ethylhexanoate, and 2 mL of methylene chloride (MeCl), and the reaction mixture was melted by heating to 90° C. After most of the solvent was evaporated, the system was then stirred under vacuum at 200° C. for 5 h and then cooled to room temperature (RT) under slow stirring. The resulting MD was dissolved in MeCl, precipitated in anhydrous ether, filtered, and dried (yield 90%).

The reaction is shown in FIG. 1 as the step (a). Some representative MDs synthesized in this study are shown in Table 1 below.

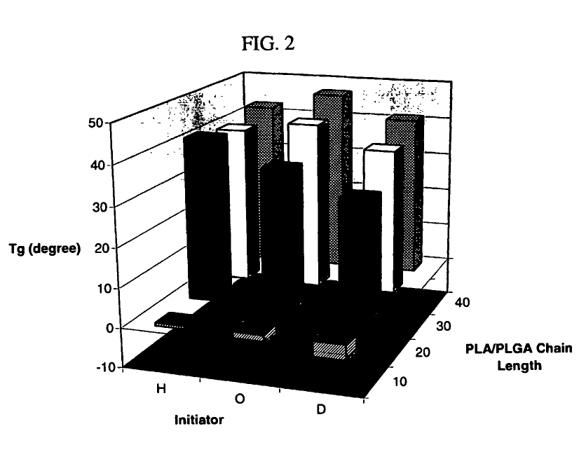

MDs were readily soluble in THF although the PLA content in the molecule was as high as about 98% by weight. This is contrary to pure PLA, which is insoluble in THF. This could be due to the decrease in long-range order in the PLA phase in these novel polyesters as compared to PLA alone. As shown in FIG. 2, for the same initiator core, the glass transition temperatures (T_{g}) of these MDs increased as the PLA chain length increased from 10 to 40 repeat units (monomers). This effect was most obvious when the initiator core was 1,8-octanediol (O) or 1,12-dodecanediol (D). This could be due to an increase in order along the MD backbone as the PLA chain length increased. It was also observed that for the same PLA length, T_{g} decreased as the initiator core C-chain increased. This may be due to the increased flexibility of the MD chain with increasing core C-chain length resulting in lower T_{g}.

### Example 2

### Synthesis of Surface-Eroding Polyesters

The MDs (synthesized a described in Example 2) were linked using hydrophobic diacid dichlorides of varying carbon length (C₆, C₈, C₁₀, and C₁₂) to form higher molecular weight (MW) polyesters. The synthesis of polyesters derived from MDs with adipoyl chloride is described below. 3 g of the MD was dissolved in 40 mL of MeCl in a 100-mL round-bottom flask. To this solution, 0.55 g of adipoyl chloride was added drop-wise at RT. After about 1 h, 0.61 g of triethylamine was added drop-wise to the flask, and the contents of the flask were stirred for an additional 4 h at RT. The reaction mixture was then washed with 100 mL of semi-saturated sodium bicarbonate and the organic MeCl phase was separated. The MeCl phase was dried with anhydrous sodium sulfate and filtered to yield a yellow colored solution. The polymer was obtained by precipitating in a large excess of hexanes and purified by re-precipitation from MeCl in hexanes. The fibrous solid so obtained was dried at 50° C. under vacuum for 3 days. A library of various polyesters (as shown in Tables 2-4) was similarly synthesized. The polymer yield was at least 90%.

### Example 3

### Characterization of MDs and Polyesters

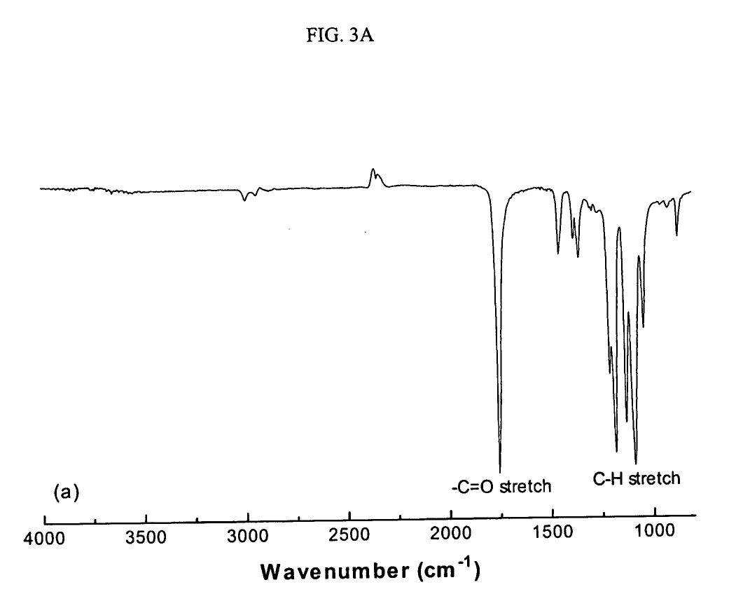

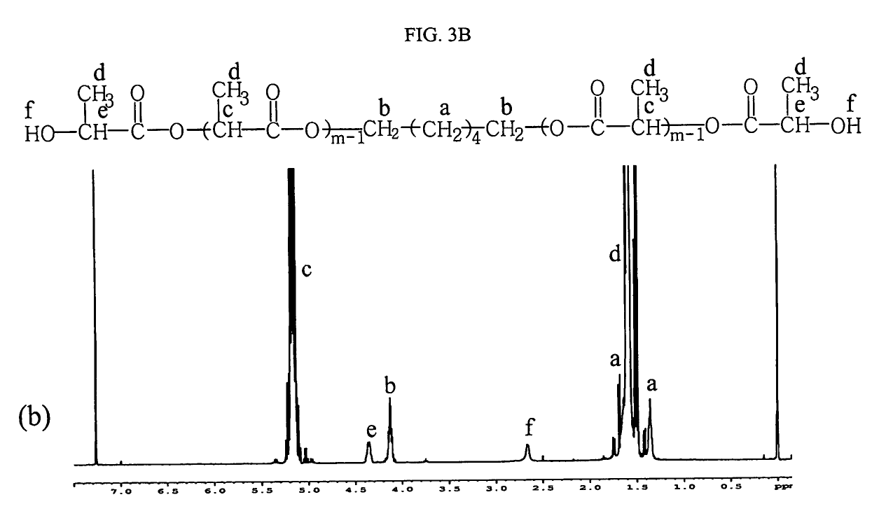

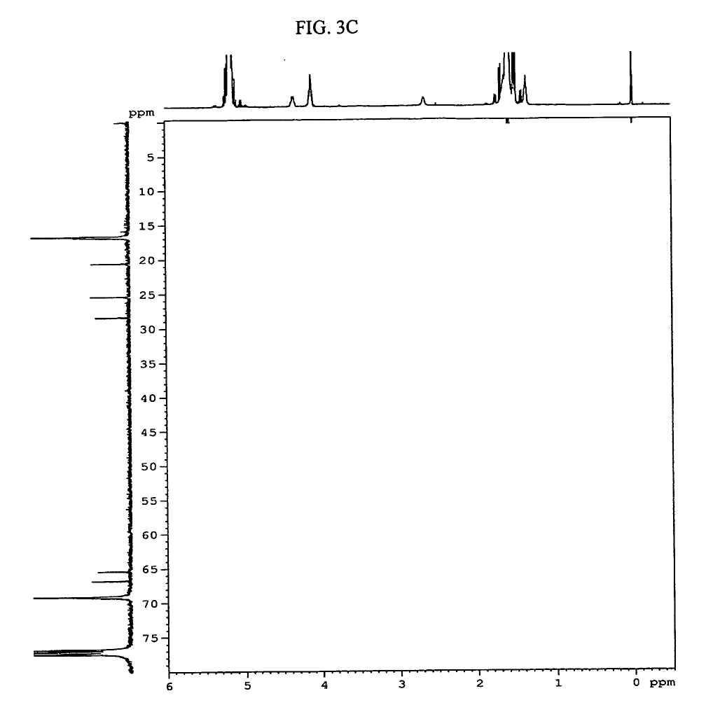

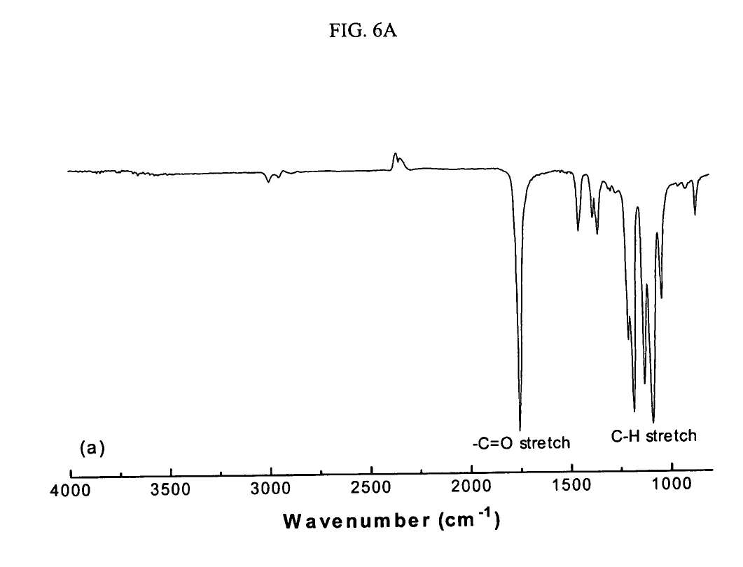

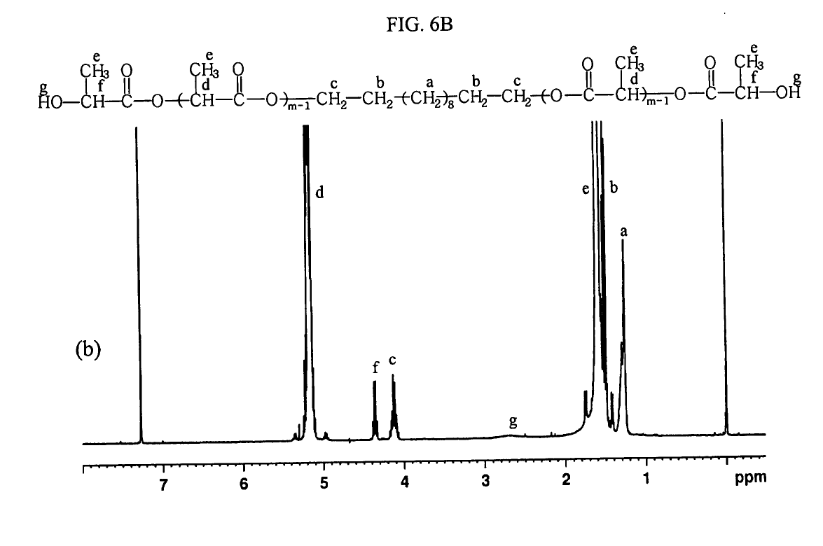

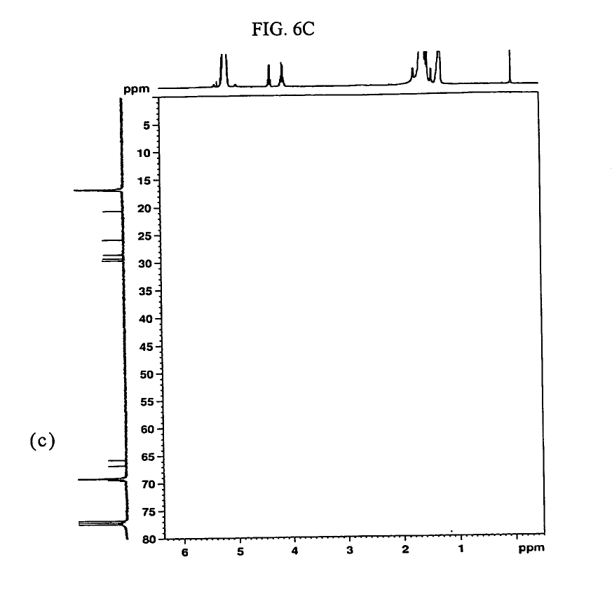

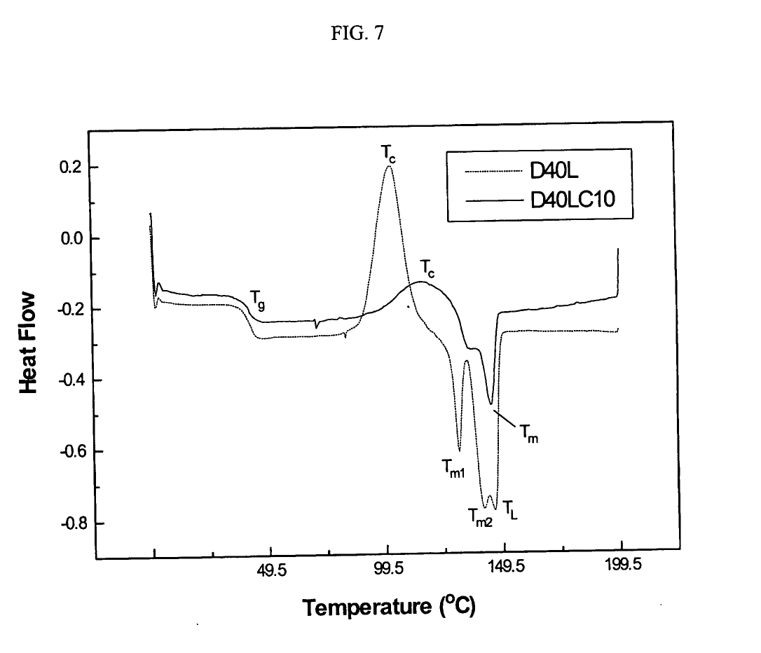

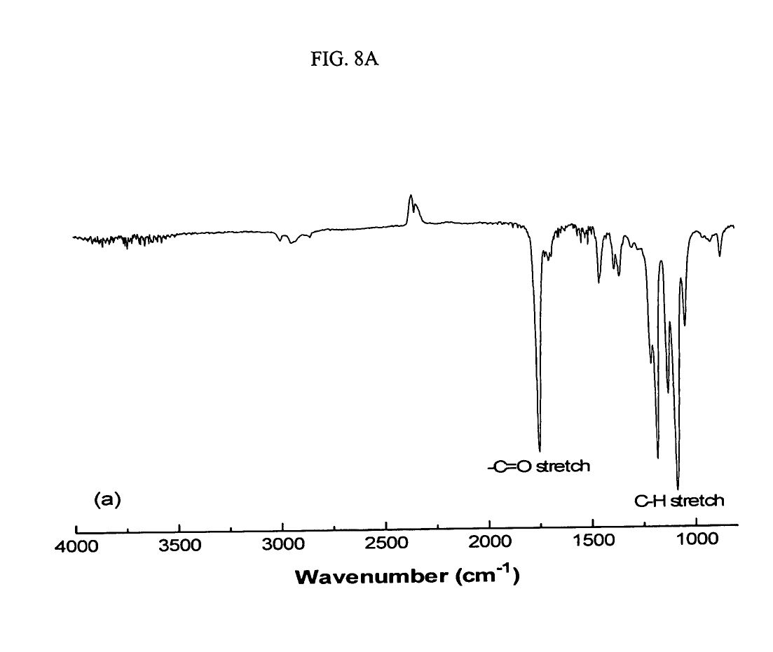

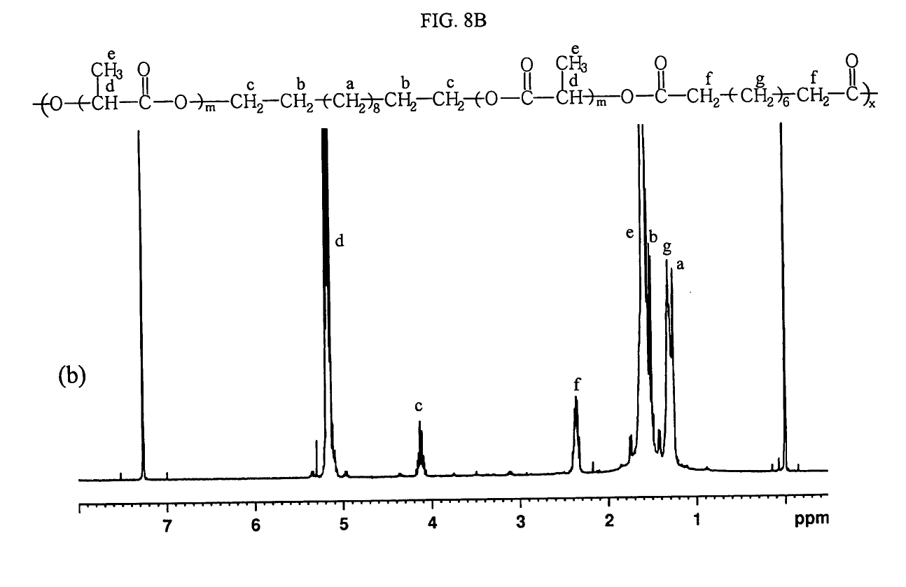

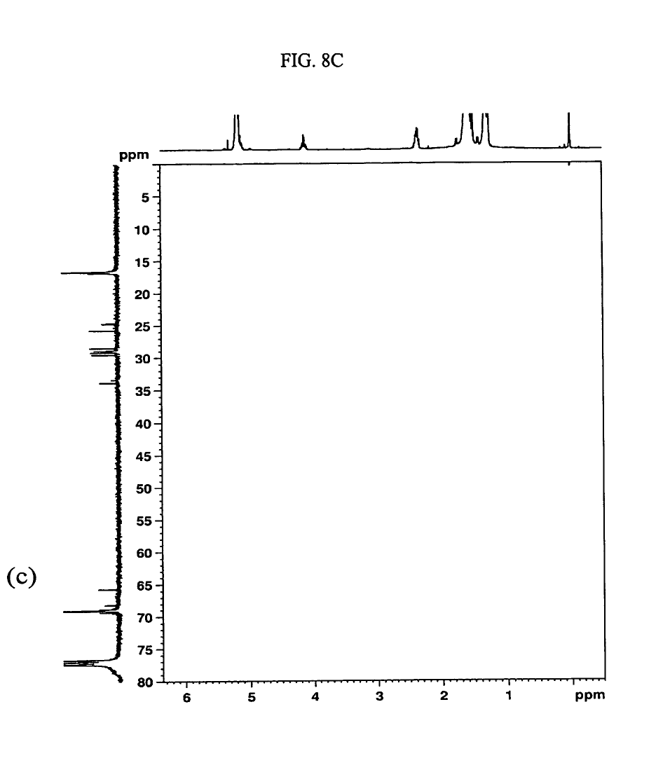

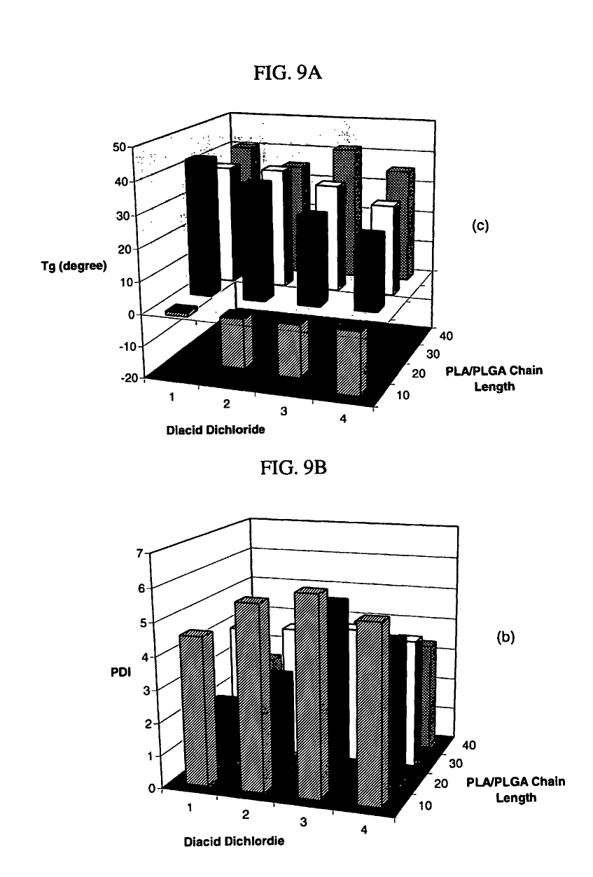

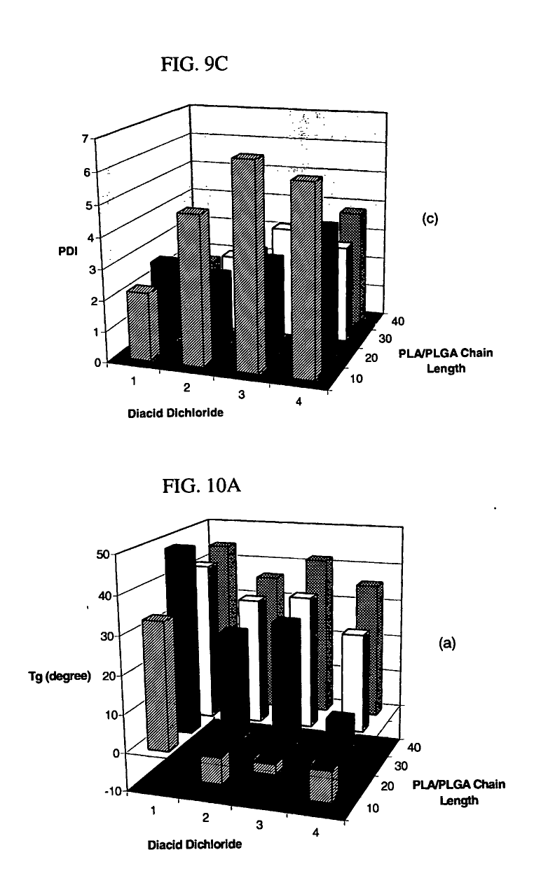

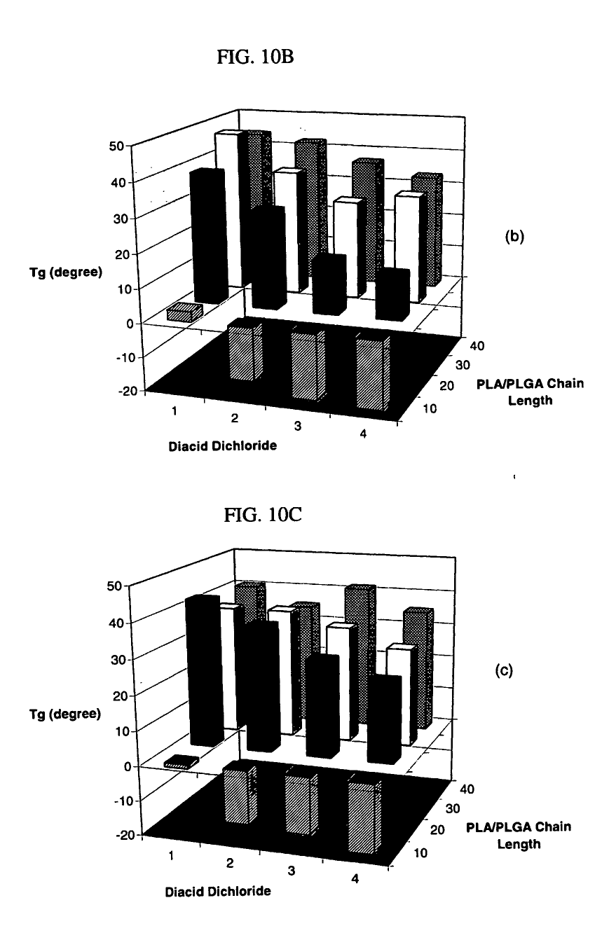

The MDs and polymers derived there from were characterized using FTIR, ¹H and ¹³C NMR and gel permeation chromatography (GPC). Results are presented in Tables 1-4 and FIGS. 2-4B and 6A-10C. The purity of the MD was verified using ¹H—¹³C correlation spectroscopy prior to the coupling step. The thermal transitions in the MD and polymers were determined using modulated DSC. Polymer films were prepared by spin coating on ultrasonically cleaned glass slides, and their surface morphologies were mapped using atomic force microscopy (AFM) in the tapping mode. The physical characteristics of the polymer wafer (surface and cross-sectional) before and after degradation were analyzed using scanning electron microscopy (SEM).

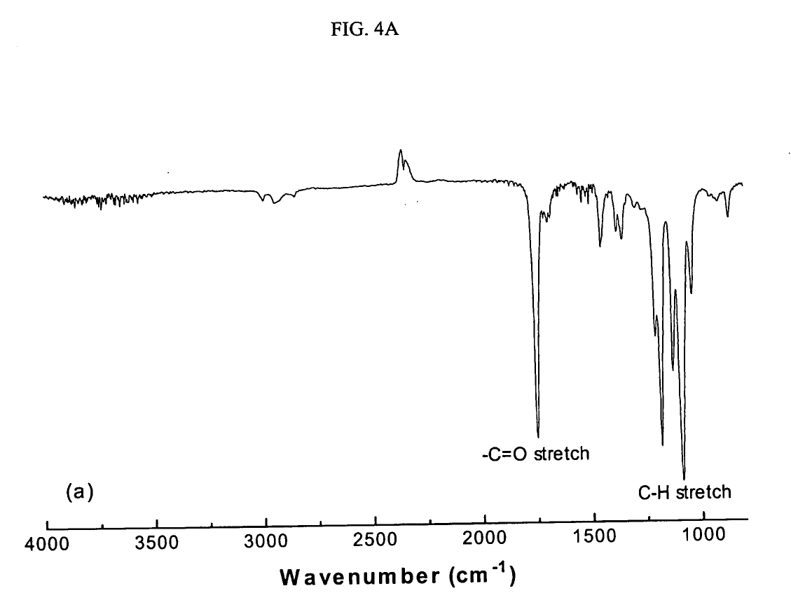

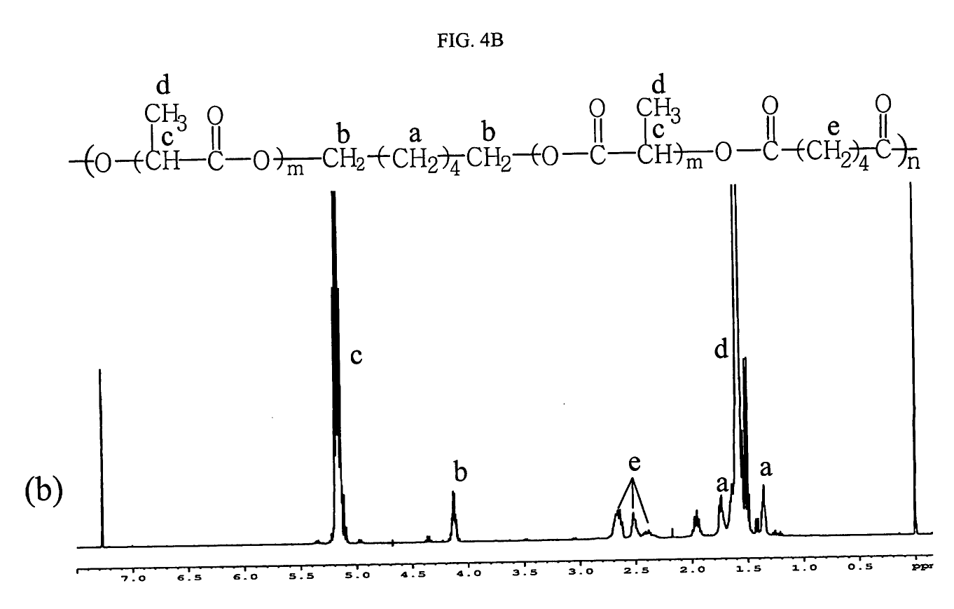

Surface eroding polyesters were obtained by condensation polymerization, by linking the MDs using a variety of hydrophobic diacid dichlorides as shown in FIG. 1, step (b). Similarly to the MDs, corresponding polyesters were also readily soluble in THF even though the PLA content in the polyester ranged from about 80 to 96 wt %. The molecular weight (M_{w}) of the polyesters ranged from about 20 KDa to 120 KDa/mol with polydispersity index (PDI) ranging from about 1.5 to 6. This corresponds to polyesters composed of 4 to 30 MD units since the molecular weight of MDs ranged from 1.4 (10 lactide or glycolide units) to 5.6 (40 lactide or glycolide units) KDa/mol. A typical FTIR spectrum of the polyester reveals a strong adsorption band at about 1756 cm⁻¹ due to the —C═O stretch from the lactidyl moieties and a prominent peak at 1110 cm⁻¹ that can be attributed to the C-H stretch. The FTIR and ¹H-NMR spectra are shown in FIGS. 4A-4B. The absence of the peak associated with the terminal hydroxy proton of the MD H20L, at 2.65 ppm and the appearance of peaks between 2.3-2.6 ppm due to the —CH₂ protons of adipoyl chloride are indicative of polymer formation.

### Example 4

### In Vitro Degradation of Polymer Wafers

Polymer wafers (7.8 mm diameter, 1 mm thickness, 50 mg/pellet) were prepared by compression of polymer powder in hardened stainless steel molds under a pressure of 32 MPa at RT. The wafers were submersed in phosphate buffer adjusted to pH 5, 7.4, and 10 and hydrated for a period of 15 days under constant stirring at 37° C., with buffer solutions being replaced every 72 hours. Hydrated weights as well as pH of solutions were measured and recorded every 72 h during this period. On day 15th, wafers were removed and dried for 72 h in a vacuum oven at 40° C. Dry mass was recorded and wafers were re-hydrated, with buffer solution, which was changed every 48 h. The drying procedure was repeated on days 20, 25, etc. of the study in order to obtain the dry mass of the wafers.

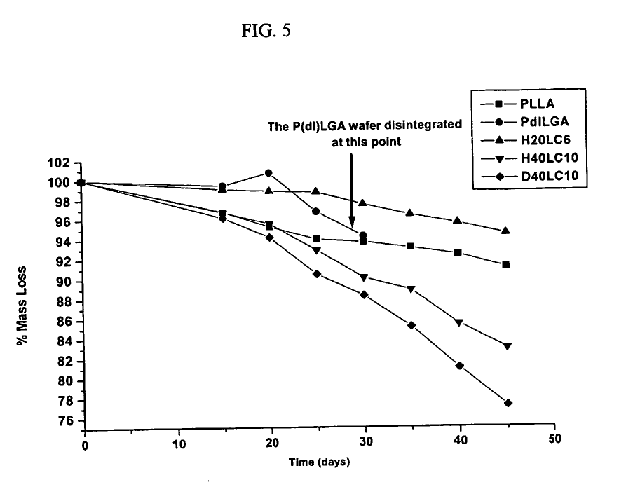

The degradation of the current polyesters and commercial PLA and PLGA at different pH values as a function of time was studied, and some of the preliminary results are shown in FIG. 5. It was observed that polyesters obtained from the present study exhibited almost steady and linear degradation profiles over at least a 2-month period. SEM analyses revealed an erosion zone localized to the edges with a solid undegraded core. AFM analyses of thin films showed that these novel polyesters exhibit topological characteristics that are significantly different from both PLA and PLGA including the presence of highly ordered nanometer-sized domains.

While the invention has been described in detail and with reference to specific examples thereof, it will be apparent to one skilled in the art that various changes and modifications can be made therein without departing from the spirit and scope thereof.

TABLE 1
Macromer diols from the ring opening polymerization of L-lactide or the mixture of L-lactide/glycolide
initiated by alkanediols

| | | | | | PLA or | Solu- | | | | | |
|---|---|---|---|---|---|---|---|---|---|---|---|
| Macromer | | | DP of | | PLGA | bility | T_{g} | T_{c} | Tₘ₁ | Tₘ₂ | T_{L} |
| diol | Initiator | Lactone | polyester | Appearance | (wt %) | in THF | (° C.) | (° C.) | (° C.) | (° C.) | (° C.) |
| H10L | 1,6- | L-lactide | 6 | viscous | 88.0 | soluble | −3.83 | no | no | no | no |
| | hexanediol | | | liquid | | | | | | | |
| H20L | 1,6- | L-lactide | 20 | powder-like | 96.1 | soluble | 41.85 | 98.87 | 124.40 | 132.07 | 139.23 |
| | hexanediol | | | solid | | | | | | | |
| H30L | 1,6- | L-lactide | 31 | powder-like | 97.4 | soluble | 40.22 | 73.58 | 125.56 | 129.37 | 141.58 |
| | hexanediol | | | solid | | | | 94.86 | | | |
| H40L | 1,6- | L-lactide | 39 | powder-like | 97.9 | soluble | 42.77 | 101.02 | 130.19 | 140.30 | 147.59 |
| | hexanediol | | | solid | | | | | | | |
| H20LG | 1,6- | L-lactide/ | 20 | viscous solid | 95.9 | soluble | 28.34 | no | no | no | no |
| | hexanediol | glycolide | | | | | | | | | |
| | | (3/1) | | | | | | | | | |
| O10L | 1,8- | L-lactide | 8 | viscous | 88.8 | soluble | −1.56 | no | no | no | no |
| | octanediol | | | liquid | | | | | | | |
| O20L | 1,8- | L-lactide | 20 | powder-like | 95.2 | soluble | 35.50 | 100.38 | 114.47 | no | 126.77 |
| | octanediol | | | solid | | | | | | | |
| O30L | 1,8- | L-lactide | 31 | powder-like | 96.8 | soluble | 42.76 | 101.83 | 129.20 | 137.70 | 144.47 |
| | octanediol | | | solid | | | | | | | |
| O40L | 1,8- | L-lactide | 39 | powder-like | 97.5 | soluble | 47.08 | 98.55 | 136.66 | 145.14 | 149.86 |
| | octanediol | | | solid | | | | | | | |
| D10L | 1,12- | L-lactide | 10 | viscous | 85.1 | soluble | −0.71 | no | no | no | no |
| | docecanediol | | | liquid | | | | | | | |
| D20L | 1,12- | L-lactide | 20 | powder-like | 93.4 | soluble | 29.70 | 94.34 | 114.41 | no | 131.02 |
| | docecanediol | | | solid | | | | | | | |
| D30L | 1,12- | L-lactide | 32 | powder-like | 95.8 | soluble | 37.21 | 95.14 | 123.45 | no | 140.11 |
| | docecanediol | | | solid | | | | | | | |
| D40L | 1,12- | L-lactide | 38 | powder-like | 96.4 | soluble | 41.37 | 103.07 | 130.90 | 140.24 | 146.38 |
| | docecanediol | | | solid | | | | | | | |
| D20LG | 1,12- | L-lactide/ | 20 | Viscous | 93.1 | soluble | 29.08 | no | no | no | no |
| | docecanediol | glycolide | | solid | | | | | | | |
| | | (3/1) | | | | | | | | | |

TABLE 2
Polyesters Derived from Macromer Diols using 1,6-Hexanediol as an Initiator

| | | | | PLA or | Solu- | | | | | |
|---|---|---|---|---|---|---|---|---|---|---|
| | Macromer | Diacid | | PLGA | bility | M_{w} | | T_{g} | T_{c} | Tₘ |
| Polymer | diol | dichloride | Appearance | (wt %) | in THF | (g/mol) | PDI | (° C.) | (° C.) | (° C.) |
| H10LC6 | H10L | adipoyl chloride | viscous soft solid | 79.0 | soluble | 10891 | 3.6 | 33.36 | no | no |
| H10LC10 | H10L | sebacoyl chloride | viscous soft solid | 77.0 | soluble | 40625 | 6.3 | −2.62 | no | no |
| H20LC6 | H20L | adipoyl chloride | fiber-like solid | 92.6 | soluble | 56455 | 2.3 | 48.39 | 115.58 | 129.57 |
| | | | | | | | | | | 137.28 |
| H20LC8 | H20L | suberoyl chloride | fiber-like solid | 91.8 | soluble | 23159 | 3.3 | 27.69 | 84.86 | 107.07 |
| | | | | | | | | | | 122.68 |
| H20LC10 | H20L | sebacoyl chloride | fiber-like solid | 91.0 | soluble | 31140 | 6.0 | 31.33 | 101.08 | 115.49 |
| | | | | | | | | | | 123.27 |
| H20LC12 | H20L | dodecanedioyl | fiber-like solid | 90.2 | soluble | 22051 | 5.7 | 7.83 | 31.99 | 102.62 |
| | | dichloride | | | | | | | 83.76 | 114.16 |
| H30LC6 | H30L | adipoyl chloride | fiber-like solid | 95.1 | soluble | 14366 | 1.5 | 41.32 | 101.95 | 129.04 |
| | | | | | | | | | | 137.14 |
| | | | | | | | | | | 143.98 |
| H30LC8 | H30L | suberoyl chloride | fiber-like solid | 94.5 | soluble | 21659 | 3.1 | 32.99 | 79.87 | 115.08 |
| | | | | | | | | | 94.60 | 141.50 |
| H30LC10 | H30L | sebacoyl chloride | fiber-like solid | 94.0 | soluble | 35494 | 4.4 | 34.61 | 60.16 | 113.27 |
| | | | | | | | | | 82.04 | 139.66 |
| H30LC12 | H30L | dodenedioyl | fiber-like solid | 93.4 | soluble | 30064 | 4.5 | 25.87 | 75.28 | 111.85 |
| | | dichloride | | | | | | | | 136.96 |
| H40LC6 | H40L | adipoyl chloride | fiber-like solid | 96.1 | soluble | 22197 | 1.9 | 44.20 | 99.64 | 133.67 |
| | | | | | | | | | | 137.16 |
| | | | | | | | | | | 149.21 |
| H40LC8 | H40L | suberoyl chloride | fiber-like solid | 95.6 | soluble | 26257 | 2.3 | 36.21 | 79.24 | 118.04 |
| | | | | | | | | | 97.06 | 147.20 |
| H40LC10 | H40L | sebacoyl chloride | fiber-like solid | 95.2 | soluble | 42007 | 2.2 | 41.74 | 114.50 | 135.21 |
| | | | | | | | | | | 147.62 |
| H40LC12 | H40L | dodecanedioyl | fiber-like solid | 94.7 | soluble | 32237 | 3.2 | 35.62 | 47.16 | 146.74 |
| | | dichloride | | | | | | | 73.36 | |
| | | | | | | | | | 117.68 | |
| H20LGC6 | H20LG | adipoyl chloride | powder-like solid | 92.3 | soluble | 10659 | 1.9 | 31.96 | no | no |
| H20LGC10 | H20LG | sebacoyl chloride | powder-like solid | 90.5 | soluble | 21616 | 3.2 | 21.36 | no | no |

TABLE 3
Polyesters Derived from Macromer Diols using 1,8-Octanediol as an Initiator

| | | | | PLA or | Solu- | | | | | |
|---|---|---|---|---|---|---|---|---|---|---|
| | Macromer | Diacid | | PLGA | bility | M_{w} | | T_{g} | T_{c} | Tₘ |
| Polymer | diol^{a} | dichloride | Appearance | (wt %) | in THF | (g/mol) | PDI | (° C.) | (° C.) | (° C.) |
| O10LC6 | O10L | adipoyl chloride | viscous soft solid | 81.7 | soluble | 19159 | 4.6 | 2.94 | no | no |
| O10LC8 | O10L | suberoyl chloride | viscous soft solid | 80.1 | soluble | 19256 | 5.6 | −15.63 | no | no |
| O10LC10 | O10L | sebacoyl chloride | viscous soft solid | 78.6 | soluble | 29750 | 6.0 | −19.15 | 57.84 | 81.38 |
| | | | | | | | | | | 101.00 |
| O10LC12 | O10L | dodecanedioyl | viscous soft solid | 77.1 | soluble | 14691 | 5.3 | −19.84 | 31.85 | 86.29 |
| | | dichloride | | | | | | | 48.34 | |
| | | | | | | | | | 60.19 | |
| | | | | | | | | | 68.29 | |
| O20LC6 | O20L | adipoyl chloride | fiber-like solid | 91.8 | soluble | 22891 | 2.0 | 38.69 | 104.64 | 117.44 |
| | | | | | | | | | | 124.86 |
| O20LC8 | O20L | suberoyl chloride | fiber-like solid | 91.0 | soluble | 23385 | 3.0 | 28.75 | 92.66 | 110.79 |
| | | | | | | | | | | 122.67 |
| O20LC10 | O20L | sebacoyl chloride | fiber-like solid | 90.2 | soluble | 34665 | 5.4 | 15.80 | 52.93 | 104.71 |
| | | | | | | | | | 86.15 | 118.49 |
| O20LC12 | O20L | dodeanedioyl | fiber-like solid | 89.4 | soluble | 29010 | 4.4 | 12.94 | 79.9 | 105.20 |
| | | dichloride | | | | | | | | 121.63 |
| O30LC6 | O30L | adipoyl chloride | fiber-like solid | 94.5 | soluble | 129862 | 3.9 | 47.13 | 114.96 | 133.54 |
| | | | | | | | | | | 144.06 |
| O30LC8 | O30L | suberoyl chloride | fiber-like solid | 94.0 | soluble | 42930 | 4.0 | 36.53 | 88.42 | 120.83 |
| | | | | | | | | | | 139.25 |
| O30LC10 | O30L | sebacoyl chloride | fiber-like solid | 93.4 | soluble | 39584 | 4.2 | 28.63 | 46.09 | 115.50 |
| | | | | | | | | | 76.32 | 138.77 |
| O30LC12 | O30L | dodecanedioyl | fiber-like solid | 92.9 | soluble | 29671 | 3.9 | 31.43 | 40.14 | 140.05 |
| | | dichloride | | | | | | | 74.76 | |
| | | | | | | | | | 107.42 | |
| O40LC6 | O40L | adipoyl chloride | fiber-like solid | 95.6 | soluble | 20290 | 2.5 | 44.22 | 103.43 | 135.27 |
| | | | | | | | | | | 144.54 |
| O40LC8 | O40L | suberoyl chloride | fiber-like solid | 95.2 | soluble | 25622 | 2.6 | 42.42 | 88.12 | 126.82 |
| | | | | | | | | | | 145.06 |
| O40LC10 | O40L | sebacoyl chloride | fiber-like solid | 94.7 | soluble | 40471 | 4.0 | 37.06 | 80.50 | 145.16 |
| | | | | | | | | | 118.54 | |
| O40LC12 | O40L | dodecanedioyl | fiber-like solid | 94.3 | soluble | 39045 | 3.4 | 33.39 | 47.35 | 144.79 |
| | | dichloride | | | | | | | 75.04 | |
| | | | | | | | | | 116.14 | |

TABLE 4
Polyesters Derived from Macromers Diols using 1,12-dodecanediol an Initiator

| | | | | PLA or | Solu- | | | | | |
|---|---|---|---|---|---|---|---|---|---|---|
| | Macromer | Diacid | | PLGA | bility | M_{w} | | T_{g} | T_{c} | Tₘ |
| Polymer | diol^{a} | dichloride | Appearance | (wt %) | in THF | (g/mol) | PDI | (° C.) | (° C.) | (° C.) |
| D10LC6 | D10L | adipoyl chloride | viscous soft solid | 82.1 | soluble | 5349 | 2.2 | −1.15 | no | no |
| D10LC8 | D10L | suberoyl chloride | viscous soft solid | 80.8 | soluble | 34124 | 9.8 | −15.37 | 96.34 | 110.36 |
| D10LC10 | D10L | sebacoyl chloride | viscous soft solid | 79.6 | soluble | 47436 | 6.5 | −16.26 | 58.42 | 101.32 |
| D10LC12 | D10L | dodecanedioyl | viscous soft solid | 78.3 | soluble | 36596 | 11.0 | −19.65 | 17.04 | 109.68 |
| | | dichloride | | | | | | | 33.92 | |
| | | | | | | | | | 49.90 | |
| | | | | | | | | | 59.19 | |
| D20LC6 | D20L | adipoyl chloride | fiber-like solid | 90.2 | soluble | 42938 | 2.6 | 42.64 | 103.19 | 121.98 |
| | | | | | | | | | | 131.60 |
| D20LC8 | D20L | suberoyl chloride | fiber-like solid | 89.4 | soluble | 15496 | 2.4 | 16.15 | 80.01 | 104.13 |
| | | | | | | | | | | 119.80 |
| D20LC10 | D20L | sebacoyl chloride | fiber-like solid | 88.6 | soluble | 25820 | 3.0 | 27.68 | 79.71 | 111.64 |
| | | | | | | | | | 95.15 | 130.29 |
| D20LC12 | D20L | dodecanedioyl | fiber-like solid | 87.9 | soluble | 25507 | 4.2 | 22.97 | 43.84 | 107.37 |
| | | dichloride | | | | | | | 73.41 | 130.86 |
| D30LC6 | D30L | adipoyl chloride | fiber-like solid | 93.6 | soluble | 24532 | 1.8 | 36.99 | 97.16 | 123.08 |
| | | | | | | | | | | 139.57 |
| D30LC8 | D30L | suberoyl chloride | fiber-like solid | 93.1 | soluble | 20823 | 2.5 | 37.12 | 86.92 | 120.75 |
| | | | | | | | | | | 131.47 |
| | | | | | | | | | | 140.49 |
| D30LC10 | D30L | sebacoyl chloride | fiber-like solid | 92.6 | soluble | 35156 | 3.6 | 33.24 | 82.84 | 117.55 |
| | | | | | | | | | 99.18 | 137.50 |
| D30LC12 | D30L | dodecanedioyl | fiber-like solid | 92.0 | soluble | 26777 | 3.1 | 28.11 | 49.19 | 136.61 |
| | | dichloride | | | | | | | 76.67 | |
| | | | | | | | | | 105.44 | |
| D40LC6 | D40L | adipoyl chloride | fiber-like solid | 94.6 | soluble | 19809 | 1.7 | 40.49 | 98.63 | 136.30 |
| | | | | | | | | | | 149.42 |
| D40LC8 | D40L | suberoyl chloride | fiber-like solid | 94.1 | soluble | 34834 | 2.2 | 35.11 | 76.65 | 146.96 |
| | | | | | | | | | 96.40 | |
| | | | | | | | | | 119.66 | |
| D40LC10 | D40L | sebacoyl chloride | fiber-like solid | 93.7 | soluble | 74777 | 2.2 | 41.47 | 115.47 | 134.98 |
| | | | | | | | | | | 145.12 |
| D40LC12 | D40L | dodecanedioyl | fiber-like solid | 93.2 | soluble | 35102 | 3.8 | 35.29 | 56.87 | 147.04 |
| | | dichloride | | | | | | | 74.62 | |
| | | | | | | | | | 117.95 | |
| D20LGC6 | D20LG | adipoyl chloride | powder-like solid | 89.7 | soluble | 11306 | 1.7 | 30.25 | no | no |
| D20LGC10 | D20LG | sebacoyl chloride | powder-like solid | 88.1 | soluble | 26042 | 3.0 | 21.04 | no | no |

What is claimed is:

1. A polyester comprising a macromeric unit, wherein the macromeric unit comprises:
(a) at least two lactone derived units;
(b) an initiating core; and
(c) a coupling unit.

2. The polyester of claim 1, wherein the initiating core is linking the at least two lactone derived units to form a macromerdiol.

3. The polyester of claim 1, wherein the coupling unit is linking a plurality of macromerdiols.

4. The polyester of claim 1, wherein the coupling unit and the initiating core have a carbon chain of a length sufficient to alter hydrophobicity of the polyester and thereby enable the polyester to degrade according to a surface erosion mechanism.

5. The polyester of claim 1, the polyester having the structural formula:
[-[A]ₘ-[B]-[A]ₘ-[D]-]ₓ
wherein A is a lactone derived unit, B is the initiating core, C is the coupling unit, m is a number of repeats from about 4 to about 60, and x is a number of macromeric units from 1 to about 100.

6. The polyester of claim 5, wherein m is 10 to 40.

7. The polyester of claim 5, wherein A is represented by at least one of the formulas:
—[—(R₂)—C(═O)—O—]— and —[—O—C(═O)—(R₂)—]—
wherein R₂ is at least one of C₁-C₈ alkyl and a substituted C₁-C₈ alkyl having at least one carbon substituted with an aromatic group and/or a heteroatom.

8. The process of claim 5, wherein the at least two lactone derived units constitute about 10% to about 99% of the polyester.

9. The process of claim 8, wherein the at least two lactone derived units constitute 50% to 99% of the polyester.

10. The process of claim 5, wherein the lactone derived unit has a number average molecular weight of about 50 to about 12,000.

11. The process of claim 10, wherein the number average molecular weight is 50 to 6,000.

12. The process of claim 10, wherein the number average molecular weight is 50 to 2,000.

13. The polyester of claim 5, wherein B is represented by the formula:
—[R₁]—
wherein R₁ is a member selected from the group consisting of a C₂-C₁₄ linear alkyl, a substituted C₂-C₁₄ alkyl having at least one substituent group, a C₂-C₁₄ heteroalkyl, a C₂-C₁₄ branched alkyl, an alkyl having at least one unsaturated bond, and a polymer.

14. The polyester of claim 13, wherein R₁ is a member selected from the group consisting of C₆, C₈, C₁₀ and C₁₂ alkyls, a poly(ether), poly(ethylenglycol), poly(amine), poly(propyleneoxide), a block ABA copolymer of poly(oxyethylene) and poly(oxypropylene).

15. The polyester of claim 5, wherein D is represented by the formula:
[—C(═O)—(R₃)—C(═O)—]
wherein R₃ is a C₄-C₁₀ aliphatic or aromatic group.

16. The polyester of claim 15, wherein R₃ is a member selected from the group consisting of C₄, C₆, C₈, and C₁₀ alkyls.

17. The polyester of claim 1, wherein the polyester has a molecular weight from about 20 KDa to about 120 KDa.

18. A polyester comprising a macromeric unit, wherein the macromeric unit comprises:
(a) at least two lactone derived units;
(b) an initiating core, wherein the diol derived unit is linking the at least two lactone derived units to form a macromerdiol; and
(c) a coupling unit, wherein the coupling unit is linking a plurality of macromerdiols and wherein the coupling unit and the diol derived unit have a carbon chain of a length sufficient to alter hydrophobicity of the polyester and thereby enable the polyester to degrade according to a surface erosion mechanism.

19. The polyester of claim 18, wherein at least one of the at least two lactone derived units is a C₁-C₈ alkyl or a substituted C₁-C₈ alkyl, wherein at least one carbon is substituted with an aromatic group and/or a heteroatom.

20. The polyester of claim 18, wherein the initiating core is a member selected from the group consisting of C₆, C₈, C₁₀ and C₁₂ alkyls, a poly(ether), poly(ethylenglycol), poly(amine), poly(propyleneoxide), a block ABA copolymer of poly(oxyethylene) and poly(oxypropylene).

21. The polyester of claim 18, wherein the coupling unit is derived from C₆-C₁₂ aliphatic or aromatic diacyls.

22. A process of making the polyester of claim 1, the process comprising:
providing a lactone;
providing a diol;
providing a coupling agent;
reacting the lactone with the diol in a presence of a catalyst to form a macromerdiol; and
reacting the macromerdiol with the coupling agent to form the polyester.

23. The process of claim 22, wherein the lactone and the diol are provided at a first molar ratio of from about 5 to about 120.

24. The process of claim 22, wherein the lactone and the diol are provided at a first molar ratio of about 5 to about 60.

25. The process of claim 22, wherein the macrodiol and the coupling agent are provided at a second molar ratio of about 1 to about 20.

26. The process of claim 22, wherein the catalyst is a member selected from the group consisting of tin(II)-2-ethylhexanoate, aluminum isopropoxide, salts and oxides of yttrium and lanthanide.

27. The process of claim 22, wherein the lactone is a member selected from the group consisting of lactones of alpha-hydroxy acids, lactones of beta-hydroxy acids, lactones of omega-hydroxy acids, lactones of gamma-hydroxy acids, lactones of delta-hydroxy acids, lactones of epsilon-hydroxy acids, p-dioxanone, cyclic carbonates, optical isomers thereof, substituents and mixtures thereof.

28. The process of claim 27, wherein the lactone is a member selected from the group consisting of lactide, ε-caprolactone, propiolactone, butyrolactone, valerolactone, p-dioxanone and depsipeptide.

29. The process of claim 22, wherein the diol has the following structural formula:
HO—(R₁)—OH
wherein R₁ is a member selected from the group consisting of a C₂-C₁₄ linear alkyl, a substituted C₂-C₁₄ alkyl having at least one substituent group, a C₂-C₁₄ heteroalkyl, a C₂-C₁₄ branched alkyl, an alkyl having at least one unsaturated bond, and a polymer.

30. The polyester of claim 29, wherein R₁ is a member selected from the group consisting of C₆, C_{8,} C₁₀ and C₁₂ alkyls, a polyether, polyethylenglycol, polyamine, polypropyleneoxide, block ABA copolymers of poly(oxyethylene) and poly(oxypropylene).

31. The process of claim 22, wherein the coupling agent is an acyl halide.

32. The process of claim 31, wherein the coupling agent is a diacyl chloride derived from adipic acid, suberoic acid, sebacic acid, or dodecanoic acid.

33. A device manufactured from the polyester of claim 1.

34. The device of claim 33, wherein at least a part of the device is adapted to be implanted in a body.

35. The device of claim 33, wherein the at least a part of the device is adapted to deliver a bioactive agent.

36. The device of claim 35, wherein the bioactive gent is a member selected from the group consisting of an antibody, a viral vector, a growth factor, a bioactive polypeptide, a polynucleotide coding for the bioactive polypeptide, a cell regulatory small molecule, a peptide, a protein, an oligonucleotide, a gene therapy agent, a gene transfection vector, a receptor, a cell, a drug, a drug delivering agent, nitric oxide, an antimicrobial agent, an antibiotic, an antimitotic, an antisecretory agent, an anti-cancer chemotherapeutic agent, steroidal and non-steroidal anti-inflammatories, a hormone, an extracellular matrix, a free radical scavenger, an iron chelator, an antioxidant, an imaging agent, and a radiotherapeutic agent.
